(19) United States
(12) Patent Application Publication
(10) Pub. No.: US 2023/0008224 A1
(43) Pub. Date: Jan. 12, 2023

(54) VISUALIZATION OF COMPLEX DATA

(71) Applicant: NadiaNaderi LLC, Greenbrae, CA (US)

(72) Inventor: Nadia NADERI, Greenbrae, CA (US)

(21) Appl. No.: 17/858,927

(22) Filed: Jul. 6, 2022

Related U.S. Application Data
(60) Provisional application No. 63/218,661, filed on Jul. 6, 2021.
(60) Provisional application No. 63/335,947, filed on Apr. 28, 2022.

(51) Int. Cl. G06T 11/60; G06F 16/55; G06F 16/54; G06T 3/40; G06T 11/00; G06T 13/80; G06V 10/764

(52) U.S. Cl. CPC G06T 11/60; G06F 16/55; G06F 16/54; G06T 3/40; G06T 11/001; G06T 13/80; G06V 10/764; G06T 2200/24

(57) ABSTRACT

In various embodiments, a method includes receiving a data set including one or more data points; determining a layout based on an image, the layout including one or more locations in the image; generating a visualization including the image and one or more visual elements, wherein each visual element indicates at least one data point of the data set, and each visual element is located in the visualization at a location of the one or more locations of the layout based on the at least one data point indicated by the visual element; and displaying the visualization.

### CROSS-REFERENCE TO RELATED APPLICATIONS

This application claims the priority benefit of United States provisional application titled, “VISUALIZATION OF COMPLEX DATA,” filed on Jul. 6, 2021, and having Ser. No. 63/218,661, and the United States provisional application titled, “VISUALIZATION OF COMPLEX DATA,” filed on Apr. 28, 2022, and having Ser. No. 63/335,947. The subject matter of these related applications is hereby incorporated herein by reference.

### BACKGROUND

### Technical Field

The present invention relates generally to computer science and data processing and, more specifically, to visualization of complex data, including all aspects of the related hardware, software, graphical user interfaces, and algorithms associated with implementing the contemplated systems, techniques, functions, and operations set forth herein.

### Description of the Related Art

Many scenarios involve the analysis of complex data, such as multi-level data sets showing numerical data at varying levels of detail. In order to arrange such complex data in a manner that can be understood and explored, presentations often include visualizations, such as line charts, bar charts, and pie charts. For example, the data series of a data set can have various features, such as time, size, priority, and status, A chart can use one or more axes, such as a horizontal axis or a vertical axis, to indicate one or more quantitative features of each data point of each data series, such as a measurement date or a measured quantity. A chart can use one or more visual features, such as color, to convey indicate one or more categorical features of each data point of each data series, such as priority. Such visualizations can also depict data at different levels of detail, such as interactive drill-down charts in which a user selection of a data point produces another visualization with more detail about the selected data point.

One drawback of visualizations of such presentations is the difficulty of arranging the data in the visualization to convey all relevant features of the data. As a first example, some features of complex data can be difficult to arrange based on a linear axis, such as a category selected from a large number of categories that do not have any particular order. As a second example, some charts feature data points that are related, such as by chronology or parent-child relationships. A chart that shows data points positioned according to one or more axes, and with visual features to indicate categorical features, but could fail to indicate relationships between one or more data series, such as a chronological relationship between a first data series and a second data series, or a parent-child relationship between a first data series and a second data series. Using visual features, such as color-coding, to convey relationships between data series can require the inclusion of a legend, which consumes additional visual space of the visualization and can only indirectly convey the relationships.

Another drawback of visualizations of such presentations is the difficulty in visually conveying features of the complex data. For example, two- and three-dimensional charts can feature multiple axes, each of which can convey any of many features of the data, and which can require explanation via labels and/or legends that add visual clutter to the charts. Because the meaning of the visual elements included in the chart is not readily apparent or intuitive, a viewer could have to spend additional time studying the content of the chart to understand the data, and/or could misunderstand the data presented in the chart.

As the foregoing illustrates, what is needed in the art are techniques for visualization of complex data.

### SUMMARY

In various embodiments, a method includes receiving a data set including one or more data points; determining a layout based on an image, the layout including one or more locations in the image; generating a visualization including the image and one or more visual elements, where each visual element indicates at least one data point of the data set, and each visual element is located in the visualization at a location of the one or more locations of the layout based on the at least one data point indicated by the visual element; and displaying the visualization.

Further embodiments provide, among other things, one or more non-transitory computer-readable media and a system for implementing the methods described above.

At least one technical advantage of the disclosed techniques relative to the prior art is that, with the disclosed techniques, the visualization of the complex data is organized according to a layout of an image, where the location of each visual element included in the visualization provides information about at least one data point indicated by the visual element. The locations of the data points within the image can reflect aspects of the data points according to the context of the image, such as an arrangement of branches of a tree that reflect relationships among the data points indicated by each visual element of the visualization. As another technical advantage, automatically determining the layout based on the image and generating the visualization according to the layout can reduce an involvement of a user in designing and organizing the visualization. These technical advantages provide one or more technological improvements over prior art approaches.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a system configured to implement one or more aspects of the various embodiments;

FIG. 2 is a more specific block diagram of the system memory of FIG. 1, according to various embodiments;

FIG. 3 is a depiction of a block diagram of an ingestion of data by the visualization engine of FIG. 2, according to various embodiments;

FIG. 4 is a depiction of a structure of a layout based on an image and generated by the visualization engine of FIG. 2, according to various embodiments;

FIG. 5 is a depiction of a visualization based on a layout and generated by the visualization engine of FIG. 2, according to various embodiments;

FIG. 6 is another depiction of a visualization based on a layout and generated by the visualization engine of FIG. 2, according to various embodiments;

FIG. 7 is a depiction of a color scheme selected for a visualization generated by the visualization engine of FIG. 2, according to various embodiments;

FIG. 8 is another depiction of a visualization based on a layout and generated by the visualization engine of FIG. 2, according to various embodiments;

FIG. 9 is another depiction of a visualization based on a layout and generated by the visualization engine of FIG. 2, according to various embodiments;

FIG. 10 is another depiction of a visualization based on a layout and generated by the visualization engine of FIG. 2, according to various embodiments;

FIG. 11 is another depiction of a visualization based on a layout and generated by the visualization engine of FIG. 2, according to various embodiments;

FIG. 12 is a depiction of a user interaction with the visualization of FIG. 11, according to various embodiments; and

FIG. 13 is a flow diagram of method steps for configuring a computer system to generate visualizations, according to various embodiments.

### DETAILED DESCRIPTION OF EXEMPLARY EMBODIMENTS

In the following description, numerous specific details are set forth to provide a more thorough understanding of the embodiments of the present invention. However, it will be apparent to one of skill in the art that the embodiments of the present invention may be practiced without one or more of these specific details.

### System Overview

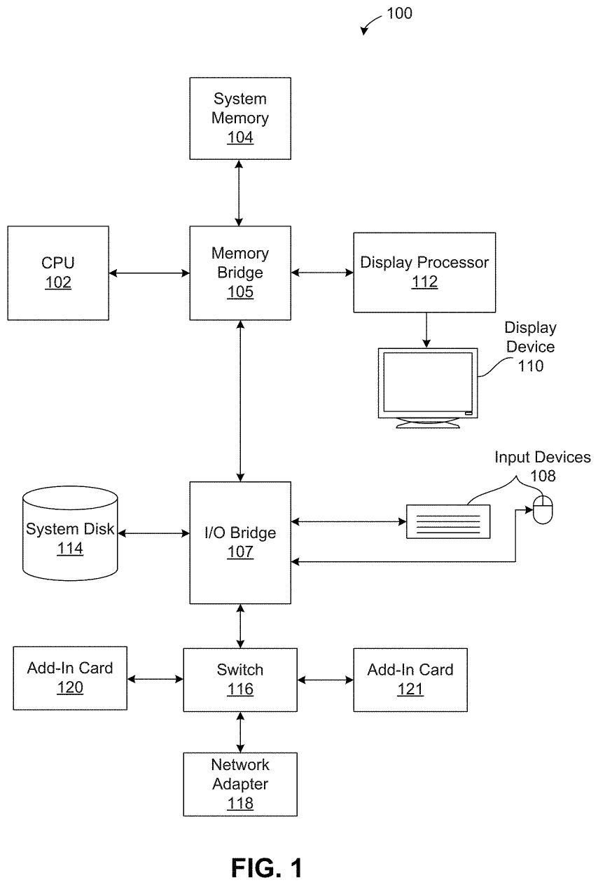

FIG. 1 depicts a system 100 within which embodiments of the present invention may be implemented. This figure in no way limits or is intended to limit the scope of the present invention. In various implementations, system 100 may be an augmented reality, virtual reality, or mixed reality system or device, a personal computer, video game console, personal digital assistant, mobile phone, mobile device or any other device suitable for practicing one or more embodiments of the present invention.

As shown, system 100 includes a central processing unit (CPU) 102 and a system memory 104 communicating via a bus path that may include a memory bridge 105, CPU 102 includes one or more processing cores, and, in operation, CPU 102 is the master processor of system 100, controlling and coordinating operations of other system components. System memory 104 stores software applications and data for use by CPU 102. CPU 102 runs software applications and optionally an operating system. Memory bridge 105, which may be, e.g., a Northbridge chip, is connected via a bus or other communication path (e.g., a HyperTransport link) to an I/O (input/output) bridge 107. I/O bridge 107, which may be, e.g., a Southbridge chip, receives user input from one or more user input devices 108 (e.g., keyboard, mouse, joystick, digitizer tablets, touch pads, touch screens, still or video cameras, motion sensors, and/or microphones) and forwards the input to CPU 102 via memory bridge 105.

A display processor 112 is coupled to memory bridge 105 via a bus or other communication path (e.g., a PCI Express, Accelerated Graphics Port, or HyperTransport link); in one embodiment display processor 112 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within system memory 104.

Display processor 112 periodically delivers pixels to a display device 110 (e.g., a screen or conventional CRT, plasma, OLED, SED or LCD based monitor or television). Additionally, display processor 112 may output pixels to film recorders adapted to reproduce computer generated images on photographic film. Display processor 112 can provide display device 110 with an analog or digital signal. In various embodiments, one or more of the various graphical user interfaces set forth in Appendices attached hereto, are displayed to one or more users via display device 110, and the one or more users can input data into and receive visual output from those various graphical user interfaces.

A system disk 114 is also connected to I/O bridge 107 and may be configured to store content and applications and data for use by CPU 102 and display processor 112. System disk 114 provides non-volatile storage for applications and data and may include fixed or removable hard disk drives, flash memory devices, and CD-ROM, DVD-ROM, Blu-ray, HD-DVD, or other magnetic, optical, or solid state storage devices.

A switch 116 provides connections between I/O bridge 107 and other components such as a network adapter 118 and various add-in cards 120 and 121. Network adapter 118 allows system 100 to communicate with other systems via an electronic communications network, and may include wired or wireless communication over local area networks and wide area networks such as the Internet.

Other components (not shown), including USB or other port connections, film recording devices, and the like, may also be connected to I/O bridge 107. For example, an audio processor may be used to generate analog or digital audio output from instructions and/or data provided by CPU 102, system memory 104, or system disk 114. Communication paths interconnecting the various components in FIG. 1 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols, as is known in the art.

In one embodiment, display processor 112 incorporates circuitry optimized for graphics and video processing, including, for example, video output circuitry, and constitutes a graphics processing unit (GPU). In another embodiment, display processor 112 incorporates circuitry optimized for general purpose processing. In another embodiment, display processor 112 may be integrated with one or more other system elements, such as the memory bridge 105, CPU 102, and I/O bridge 107 to form a system on chip (SoC). In still further embodiments, display processor 112 is omitted and software executed by CPU 102 performs the functions of display processor 112.

Pixel data can be provided to display processor 112 directly from CPU 102. In some embodiments of the present invention, instructions and/or data representing a scene are provided to a render farm or a set of server computers, each similar to system 100, via network adapter 118 or system disk 114. The render farm generates one or more rendered images of the scene using the provided instructions and/or data. These rendered images may be stored on computer-readable media in a digital format and optionally returned to system 100 for display. Similarly, stereo image pairs processed by display processor 112 may be output to other systems for display, stored in system disk 114, or stored on computer-readable media in a digital format.

Alternatively, CPU 102 provides display processor 112 with data and/or instructions defining the desired output images, from which display processor 112 generates the pixel data of one or more output images, including characterizing and/or adjusting the offset between stereo image pairs. The data and/or instructions defining the desired output images can be stored in system memory 104 or graphics memory within display processor 112. In an embodiment, display processor 112 includes 3D rendering capabilities for generating pixel data for output images from instructions and data defining the geometry, lighting shading, texturing, motion, and/or camera parameters for a scene. Display processor 112 can further include one or more programmable execution units capable of executing shader programs, tone mapping programs, and the like.

Further, in other embodiments, CPU 102 or display processor 112 may be replaced with or supplemented by any technically feasible form of processing device configured to process data and execute program code. Such a processing device could be, for example, a central processing unit (CPU), a graphics processing unit (GPU), an application-specific integrated circuit (ASIC), a field-programmable gate array (FPGA), and so forth. In various embodiments any of the operations and/or functions described herein can be performed by CPU 102, display processor 112, or one or more other processing devices or any combination of these different processors.

CPU 102, render farm, and/or display processor 112 can employ any surface or volume rendering technique known in the art to create one or more rendered images from the provided data and instructions, including rasterization, scanline rendering REYES or micropolygon rendering, raycasting, raytracing, neural rendering, image-based rendering techniques, and/or combinations of these and any other rendering or image processing techniques known in the art.

In other contemplated embodiments, system 100 may be a robot or robotic device and may include CPU 102 and/or other processing units or devices and system memory 104. In such embodiments, system 100 may or may not include other elements shown in FIG. 1. System memory 104 and/or other memory units or devices in system 100 may include instructions that, when executed, cause the robot or robotic device represented by system 100 to perform one or more operations, steps, tasks, or the like.

It will be appreciated that the system shown herein is illustrative and that variations and modifications are possible. The connection topology, including the number and arrangement of bridges, may be modified as desired. For instance, in some embodiments, system memory 104 is connected to CPU 102 directly rather than through a bridge, and other devices communicate with system memory 104 via memory bridge 105 and CPU 102. In other alternative topologies display processor 112 is connected to I/O bridge 107 or directly to CPU 102, rather than to memory bridge 105. In still other embodiments, I/O bridge 107 and memory bridge 105 might be integrated into a single chip. The particular components shown herein are optional; for instance, any number of add-in cards or peripheral devices might be supported. In some embodiments, switch 116 is eliminated, and network adapter 118 and add-in cards 120; 121 connect directly to I/O bridge 107.

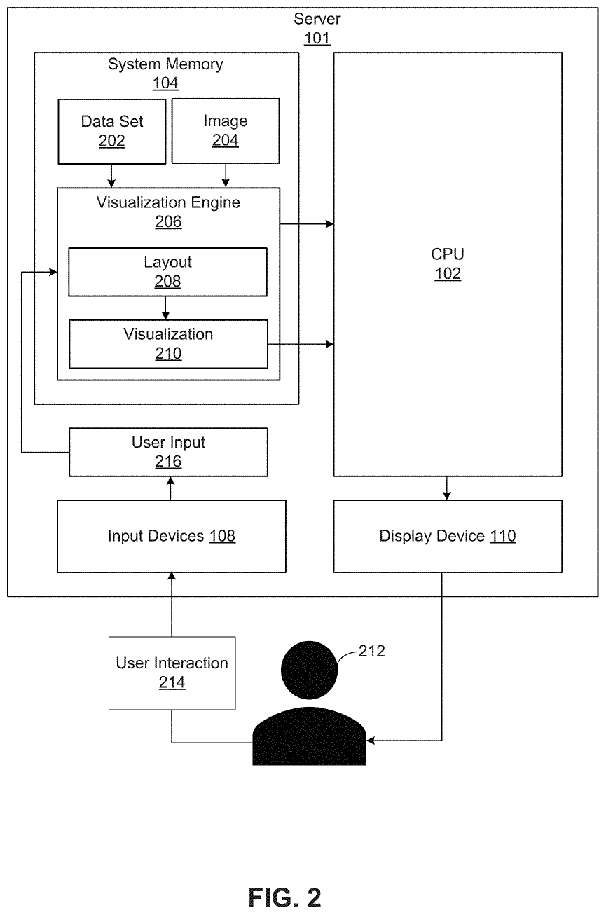

FIG. 2 is a block diagram of the system memory 104 of FIG. 1, according to various embodiments. As shown, the server 101 includes a CPU 102; system memory 104, one or more input devices 108, and a display device 110. Further, the system memory 104 includes a data set 202; an image 204; and a visualization engine 206.

The data set 202 includes one or more data points. In various embodiments, the data set 202 includes data regarding the resources and/or activities of an organization, and one or more data points of the data set 202 are respectively associated with a project of the organization. The data set 202 can be stored in and/or retrieved from a project management and tracking system, such as JIRA or the like. In various embodiments, the server 101 also stores the project management and tracking system, and/or interacts with a project management and tracking system stored on another device (e.g., via the network adapter 118) to retrieve the data set 202.

As shown, the visualization engine 206 is a program stored in the system memory 104 and executed by the CPU 102 to display, for a user 212, a visualization 210 based on the data set 202 and an image 204. In various embodiments, the image 204 is stored by the server 101 (e.g., as part of an object library in a storage device of the server 101, such as the system disk 114), retrieved from another device (e.g., via the network adapter 118), and/or from the user 212. In various embodiments, the server 101 generates at least part of the image 204 (e.g., by inserting one or more objects from an object library). As an example, the image 204 can include one or more natural objects, such as one or more trees or one or more animals. Natural objects often include semantic properties that are familiar to viewers, and images of such natural objects can be adapted to convey features of the complex data that viewers might intuitively understand.

The visualization engine 206 determines a layout 208 of the visualization 210 based on the image 204. The layout 208 includes one or more locations in the image 204 that respectively correspond to at least one data point of the data set 202. In various embodiments, the visualization engine 206 can receive an image 204 including a tree and can determine the layout 208 as one or more locations along one or more branches of the tree shown in the image 204. In various embodiments, the image includes an object with structural features that can determine the layout 208, and that viewers can intuitively understand as conveying features of the data. In various embodiments, the image 204 includes an object that has a familiar a structure, and the one or more locations of the layout 208 can correspond to the structure of the object. For example (without limitation), an image 204 of a tree includes a trunk and one or more branches that diverge from the trunk at various heights and/or directions. In a layout 208 of an image 204 including a tree, the height along the tree is associated with a chronology, and each location can be associated with a particular date. Locations that are closer to a base of the trunk of the tree are associated with dates that are older than the dates associated with locations that are higher in the tree. Also, for a branch of the tree, the distance from the trunk can be associated with a progress of a project. Projects that are associated with locations along a branch that are closer to a trunk of the tree have progressed further to completion than projects that are associated with locations that are further toward a tip of the branch. In this manner, familiar semantic properties of the structure of the tree are incorporated into the layout 208 and the determined locations of the layout 208.

The visualization engine 206 generates a visualization 210 including the image 204 and one or more visual elements. Each visual element indicates at least one data point of the data set 202 (e.g., as a geometric shape, an object, a symbol, or the like), The visualization engine 206 determines a location for each visual element, where the location is based on the layout 208 and one or more data points of the data set 202 indicated by the visual element. For example (without limitation), a visualization 210 based on an image 204 of a tree can include a visual element for each project of an organization represented in the data set 202. Each data point of the one or more data points can be associated with a project of an organization. The visualization engine 206 can determine the layout 208 based on a structure of the tree included in the image. For each project, the visualization 210 includes a visual element at a location on a branch of the tree, where the height of the branch corresponds to a date of inception and/or action of the project. Further, the visualization engine 206 can determine a location of each visual element that corresponds to a hierarchical position within the organization of the project that is indicated by the visual element. For example, the visualization 210 can position each visual element at a location along the branch, where the distance along the branch corresponds to a progress of the project toward completion. For a first project that is older and complete, the visualization engine 206 includes a first visual element in the visualization 210 that is located on a lower branch, and at a location along the lower branch that is close to the trunk of the tree. For a second project that is newer and in an early stage of progress, the visualization engine 206 includes a second visual element in the visualization 210 that is located on a higher branch, and at a location along the higher branch that is close to the tip of the branch. Because the visual elements of the data are organized in a manner that is consistent with familiar semantic properties of the structure of the tree, the visualization conveys features of the complex data in a manner that can be intuitively understood by viewers.

In various embodiments, the locations of the visual elements indicate relationships between the data points indicated by each visual element. Further, the image can include a visual relationship between a first location and a second location. The visualization engine 206 can determine that the data set includes a data relationship between a first data point in the data set and a second data point in the data set, such as a hierarchical relationship between a first project and a second project. For example, if a second project is an offshoot or descendant of a first project, a visualization of a tree can include a first visual element indicating the first project on a branch at a location near the trunk of the tree and a second visual element indicating the second project that is located further out on the same branch. Based on the data relationship, the visualization engine 206 can determine a location of a first visual element that indicates the first data point and a location of a second visual element that indicates the second data point. As a result, the locations of the visual elements can visually indicate the data relationship between the data points indicated by the visual elements. That is, the first visual element indicating a first data point can be based on a location of a second visual element indicating a second data point and a data feature that is associated with both the first data point and the second data point. Because semantic properties such as branching are familiar to viewers, visualizations that arrange the visual elements of the complex data according to these semantic concepts can improve the ease with which viewers understand corresponding features of the data.

The visualization engine 206 displays the visualization 210 to the user 212. As shown, the visualization engine 206 displays the visualization 210 via a display device 110 of the server 101. In various embodiments, the visualization engine 206 transmits the visualization 210 to a second device (e.g., via the network adapter 118) for display to a user 212 of the second device. For example (without limitation), the server 101 can include a webserver that generates a web page including the visualization 210 and transmits the web page to a client device to be displayed to a user 212 by a web browser.

In various embodiments, the visualization engine 206 receives user input 216 from the user 212. As shown, the user 212 performs a user interaction 214 with one or more input devices 108 of the server 101, such as touching a touch-sensitive portion of the display device 110 and/or manipulating a keyboard, mouse, touchpad, or the like. The one or more input devices 108 receive the user interaction 214 and determine user input 216 (e.g., detecting a touch by the user 212 at a location on a surface of the display device 110 and determining a coordinate of a virtual display space that corresponds to the location of the touch). In various embodiments, the user input 216 indicates one or more operations to be performed on the visualization 210, such as a zoom operation, a translation operation, a rotation operation, a selection of a visual element, or the like. Based on the user input 216, the visualization engine 206 updates the visualization 210 (e.g., by applying the one or more operations to the visualization 210 displayed for the user 212) and causes the updated visualization to be displayed (e.g., by the display device 110).

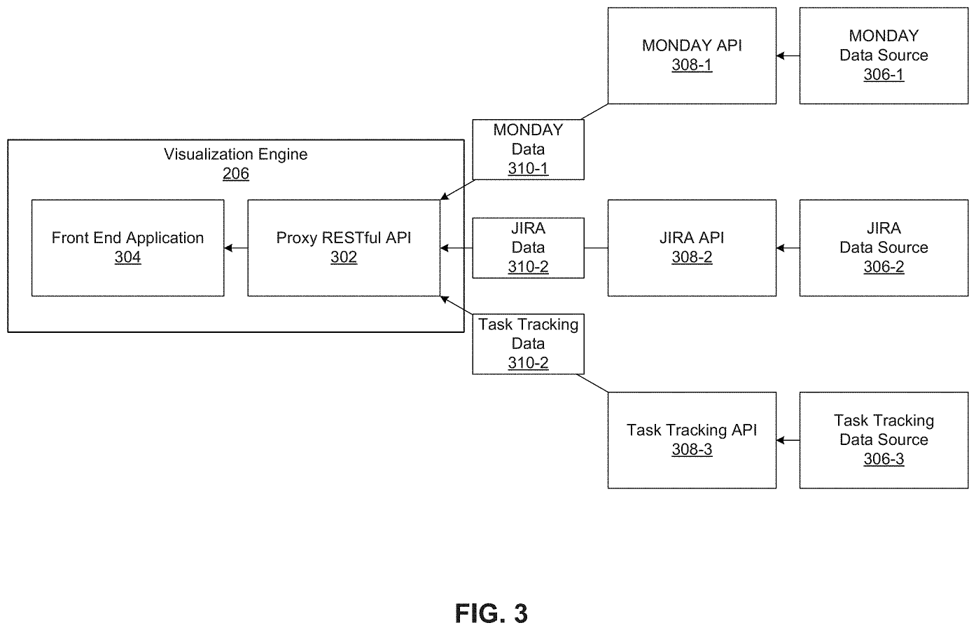

FIG. 3 is a depiction of a block diagram of an ingestion of data by the visualization engine 206 of FIG. 2, according to various embodiments. As shown, the visualization engine 206 includes a proxy RESTful application programming interface (API) 302 and a front end application 304.

The proxy RESTful application programming interface (API) 302 is a program stored in the system memory 104 and executed by the CPU 102 to retrieve a data set 202 to be depicted by a visualization 210. In various embodiments, the proxy RESTful API 302 retrieves the data set 202 from one or more data sources 306, such as a MONDAY data source 306-1, a JIRA data source 306-2, or a data source 306-3 of another task tracking application. In various embodiments, one or more of the data sources 306 is stored by the server 101 (e.g., in the system memory 104) and/or is stored by another device that is accessible to the visualization engine 206 (e.g., via the network adapter 118). As shown, each data source 306 is associated with an API 308, and the proxy RESTful API 302 can interact with each API 308 to retrieve the data set 202 from the associated data source 306. The proxy RESTful API 302 can provide an abstraction layer by which the visualization engine 206 can retrieve data 310 from a variety of data sources 306, such as a variety of task tracking applications, through a variety of APIs 308. For example, the proxy RESTful API 302 can interact with a MONDAY API 308-1 to retrieve MONDAY data 310-1 from the MONDAY data source 306-1. The proxy RESTful API 302 can interact with a JIRA API 308-2 to retrieve JIRA data 310-2 from the JIRA data source 306-2. The proxy RESTful API 302 can interact with an API 308-3 of another task tracking application to retrieve task tracking data 310-3 from the task tracking data source 306-3.

The front end application 304 is a program stored in the system memory 104 and executed by the CPU 102 to generate a front end (e.g., a graphical user interface) of the visualization engine 206. In various embodiments, the front end application 304 includes a web page featuring instructions in a programming language, such as JavaScript. When a web browser (e.g., on the server 101 or another device) renders the web page, the web browser executes the instructions included in the web page to generate one or more components, such as labels, buttons, textboxes, images, and the like. The front end application 304 causes a visualization 210 generated by the visualization engine 206 based on the retrieved data 310 to be displayed for the user 212.

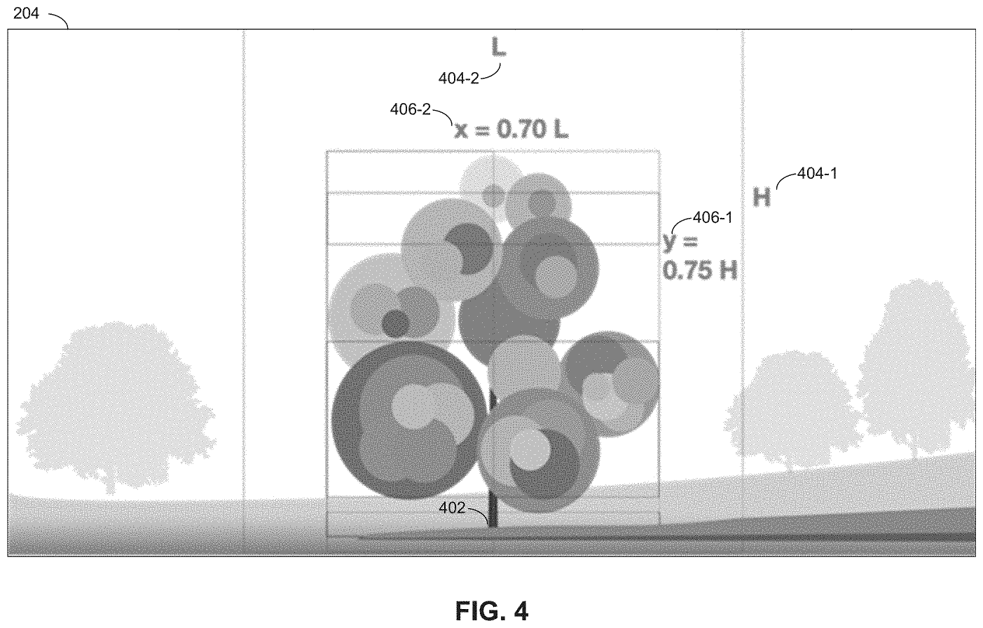

FIG. 4 is a depiction of a structure of a layout 208 based on an image 204 generated by the visualization engine 206 of FIG. 2, according to various embodiments.

As shown, the layout 208 is based on an image 204, where the image includes a ground and a number of trees, including a particular tree 402 shown in the foreground and/or center of the image 204. The visualization engine 206 determines a structure of the layout 208 for determining the locations 408 of the visual elements 410. For example, the visualization engine 206 determines that the tree 402 includes a height axis 404-1 with a height measurement 406-1. The height axis 404-1 can be associated with a chronology, and each location in the layout 208 can be associated with a particular date. Locations that are closer to a base of the trunk of the tree 402 are associated with dates that are older than the dates associated with locations that are higher in the tree 402. Also, the visualization engine 206 determines that the tree 402 includes a length axis 404-2 with a length measurement 406-2. The length axis 404-2 can be associated with a progress of a project. For example, projects that are associated with locations that are further from a midpoint of the length axis 404-2 (e.g., further from a trunk of the tree 402 positioned at the midpoint of the length axis 404-2) have progressed further to completion than projects that are associated with locations that are further toward the edges of the length axis 404-2. In this manner, familiar semantic properties of the structure of the tree 402 are incorporated into the layout 208 and the determined locations of the layout 208,

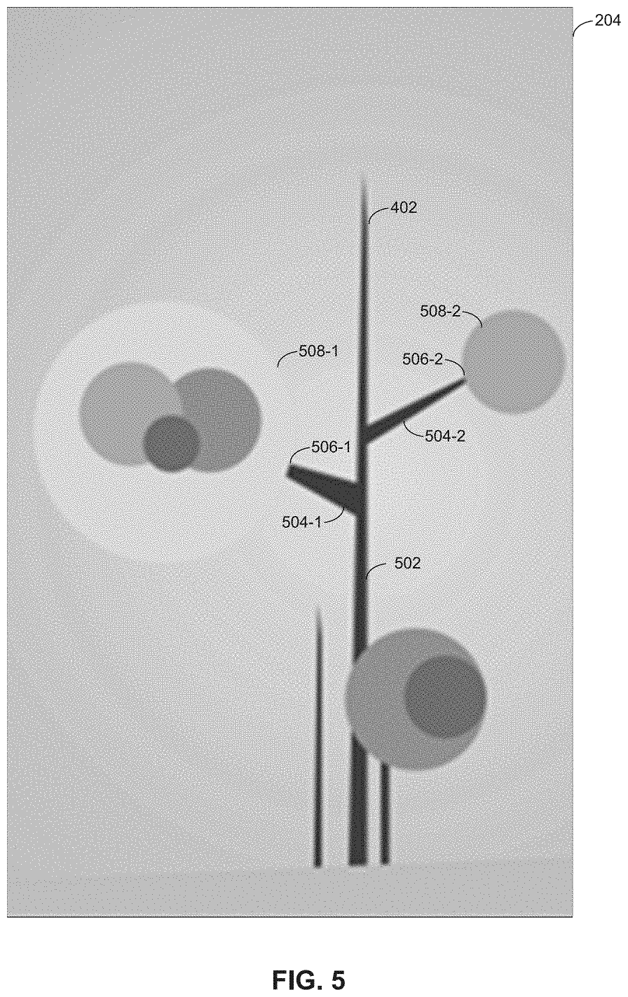

FIG. 5 is a depiction of a visualization 210 based on a layout 208 and generated by the visualization engine 206 of FIG. 2, according to various embodiments. The layout 208 can be based on a structure of an image 204 determined by the visualization engine 206 of FIG. 2, such as discussed in FIG. 4. Also, the visualization 210 can generated by the visualization engine 206 of FIG. 2.

As shown, the layout 208 is based on an image 204, such as an image of a tree 402. The layout 208 is based on a structure of the tree 402, including a trunk 502 and a plurality of branches 504-1, 504-2 diverging from the trunk 502 in different directions. The layout 208 includes a number of locations 506-1, 506-2 within the image 204, such as selected locations along each of the branches 504 of the tree 402. As discussed in relation to FIG. 4, the structure of the tree 402 includes a height axis 404-1 of the tree 402 and a length axis 404-2 distance along each branch 504 from the trunk 502. The layout 208 can be structured according to the structure of the tree 402. For example, the height along the tree 402 can be associated with a chronology, and each location 506 can be associated with a particular date. Branches 504 that are closer to the base of the trunk 502 of the tree 402 are older than branches 504 that are higher in the tree 402. Also, for a branch 504 of the tree, the distance from the trunk 502 can be associated with a progress of a project toward completion, where locations 506 on the branch 504 that are closer to the trunk 502 of the tree 402 have progressed further to completion than locations 506 that are further toward a tip of the branch 504. Because semantic properties such as branching are familiar to viewers, visualizations that arrange the visual elements of the complex data according to these semantic concepts can improve the ease with which viewers understand corresponding features of the data.

The visualization engine 206 generates a number of visual elements 508-1, 508-2 at various locations 506-1, 506-2 of the layout 208, Each visual element 508 indicates at least one data point from the data set 202, such as one or more data points of task data 310 that are associated with a particular project of an organization. More particularly, the location 506 of each visual element 508 is based on the at least one data point indicated by the visual element 508. For example, for a first project that is older and that is complete, the visualization engine 206 selects a first location 506-1 that is on a low branch 504-1 and that is located along the branch 504-1 close to the trunk 502 of the tree 402. The visualization engine 206 generates a first visual element 508-1 for the first project and includes it in the visualization 210 at the first location 506-1. For a second project that is newer and that is in an early stage of development, the visualization engine 206 selects a second location 506-2 that is on a high branch 504-2 and that is located along the branch 504-2 close to the top of the branch 504-2. The visualization engine 206 generates a second visual element 508-2 for the second project and includes it in the visualization 210 at the second location 506-2. In this manner, the location 506 of each visual element 508 indicates various features of the at least one data point indicated by the visual element 508. In various embodiments, other visual properties of the visual elements 508 can indicate other features of the at least one data point. For example, a color of each visual element 508 can indicate a timeliness of the project, and a size of each visual element 508 can indicate a priority or resource allocation of each project. In this manner, familiar semantic properties of the tree 402 are incorporated into the layout 208, the determined locations of the layout 208, and the generated visual elements 508.

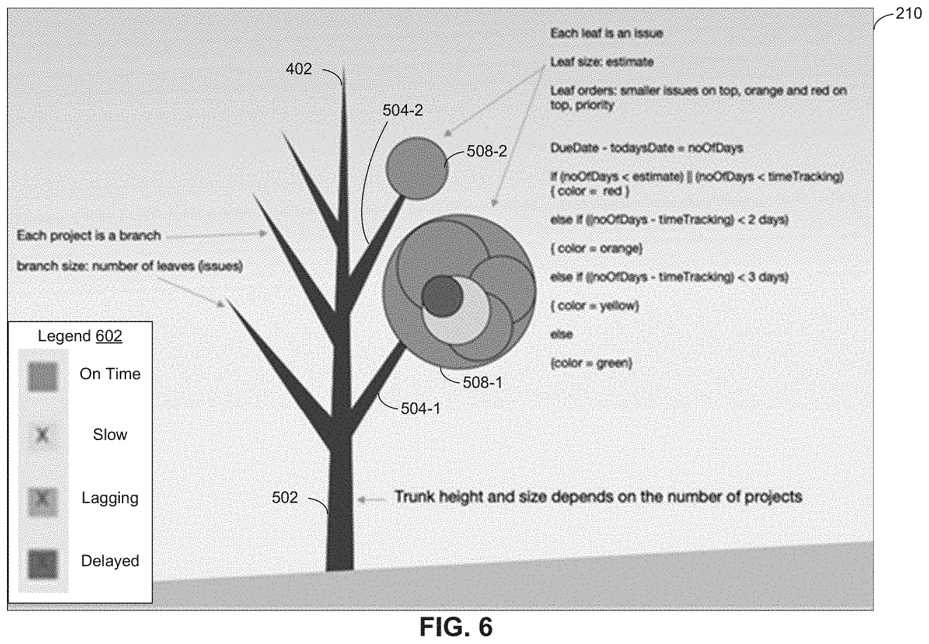

FIG. 6 is another depiction of a visualization 210 based on a layout 208 and generated by the visualization engine 206 of FIG. 2, according to various embodiments. The layout 208 can be based on a structure of an image 204, as discussed in relation to FIG. 4.

As shown, the visualization 210 includes a number of visual elements 508 that are located at various locations 506 within the visualization 210. As previously discussed, the visualization engine 206 determines the locations 506 based on an image 204, such as the depiction of a tree 402 including a trunk 502 and a number of branches 504, and the visualization 210 includes the image 204. As shown, each branch 504 of the tree 402 is associated with a different project. Also, each visual element 508 indicates an issue arising within a project, where the issues are indicated by at least one data point of the data set 202. The at least one data point associated with each issue includes a number of data features, such as a priority of the issue, an age of the issue (e.g., a number of days or noOfDays), and an estimate of a duration of the issue. The visualization engine 206 associates each branch 504 of the tree 402 with a project. The visualization engine 206 determines the location 506 of each visual element 508 based on the project associated with the issue indicated by the visual element 508. Further, the visualization engine 206 determines various visual properties of each visual element 508 based on one or more data properties of the at least one data point associated with the issue indicated by the visual element 508. For example, a size of the visual element 508 indicates an estimate of a duration of the issue. Also, the color of the visual element 508 indicates a status of the issue. For example, the status can be based on a comparison between an age of the issue (e.g., a number of days) with the estimate of the duration of the issue. The visualization 210 can include a legend 602 that indicates the status of each issue corresponding to each color. While the legend 602 can clarify the meaning of the colors, the selected colors can be based on familiar semantic properties of a natural object in the image, and therefore viewers might be able to understand the data without referring to the legend 602.

As shown, the visualization 210 includes a first visual element 508-1 at a location on a first branch 504-1 that is associated with a first project, with a large size that indicates a long estimate of the duration of the issue, and a green color to indicate a status of at least three days remaining to complete the issue. The visualization 210 also includes a second visual element 508-2 at a location on a second branch 504-2 that is associated with a second project, with a small size that indicates a short estimate of the duration of the issue, and a green color to indicate a status of at least three days remaining to complete the issue. In this manner, the visual properties of the visualization 210 indicate features of the projects (e.g., based on the branch 504 and the location 506 along the branch 504 of each visual element 508) and the issues associated with the projects (e.g., the estimate of the duration of each issue and the comparison between the age of the project and the estimate).

In various embodiments, the visualization engine 206 can also select an image 204 for a visualization 210 based on one or more data properties of the data set 202 to be indicated by the visualization 210, For example, the server 101 can store an image library including a number of images 204, each featuring one or more objects with a different structure, such as trees with different height measurements 406-1 and/or length measurements 406-2. Based on a data property of the data set 202, the visualization engine 206 can select, from the image library, an image 204 of a tree 402 that corresponds to the data property. As shown, the tree 402 in the image 204 included in the visualization 210 of FIG. 6 has a trunk height and size that corresponds to a number of projects in the data set 202. That is, visualization engine 206 can select, from an image library, an image 204 of a tree 402 with a height measurement 406-1 and/or a length measurement 406-2 that provide a sufficient number of branches 504 and/or a sufficient spacing along the height axis 404-1 and/or the length axis 404-2 for a corresponding number of visual elements 508. The selected image 204 can feature an object with which viewers are familiar, such as a tree 402 or an animal, and the visualization can arrange visual elements of the data according to familiar semantic properties of the object. As a result, the generated visualization is more intuitive and can be more easily understood by viewers.

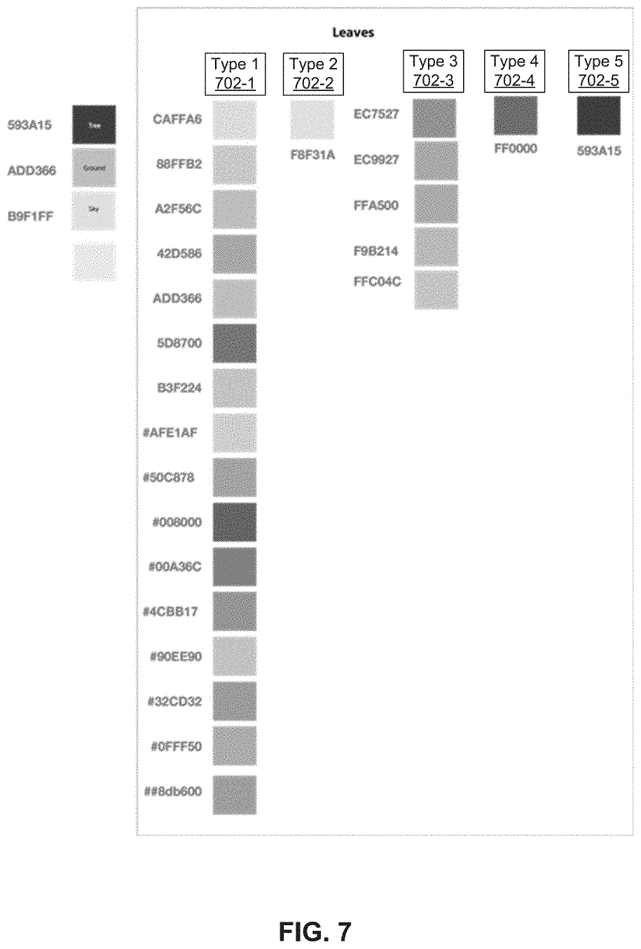

FIG. 7 is a depiction of a color scheme selected for a visualization 210 generated by the visualization engine 206 of FIG. 2, according to various embodiments. The layout 208 can be based on a structure of an image 204, as discussed in relation to FIG. 4.

In various embodiments, the data set can include one or more types 702-1, 702-2, 702-3, 702-4, 702-5 of data points. For example, each type 702 can be associated with a status of a project, such as discussed in relation to FIG. 6. Further, each type 702 can be associated with at least one color of a color scheme. For example, for the first type 702-1 (e.g., indicating at least three days remaining to complete an issue), the colors can be various but different shades of green, while for the third type 702-3 (e.g., indicating zero days remaining to complete the issue), the colors can be various but different shades of orange. While generating a visualization 210, the visualization engine 206 can select, for each visual element 508, one of the colors associated with the type 702 of the at least one data point indicated by the visual element 508. Based on the color scheme, a first visual element 508 can indicate a first at least one data point that is associated with a type 702, and a second visual element 508 can indicate a second at least one data point that is associated with the same type 702. However, in the visualization 210, the first visual element 508 can include a first color of the color scheme that is associated with the type 702, and the second visual element 508 can include a second color of the color scheme that is also associated with the type 702. Because the first color and the second color are both associated with the type 702 and are within the color scheme (e.g., shades of green), the visual elements 508 can include different colors, such as different shades of green. Using different colors of a color scheme can distinguish the visual elements 508 of the visualization 210, particularly if the visual elements 508 are adjacent and/or overlapping.

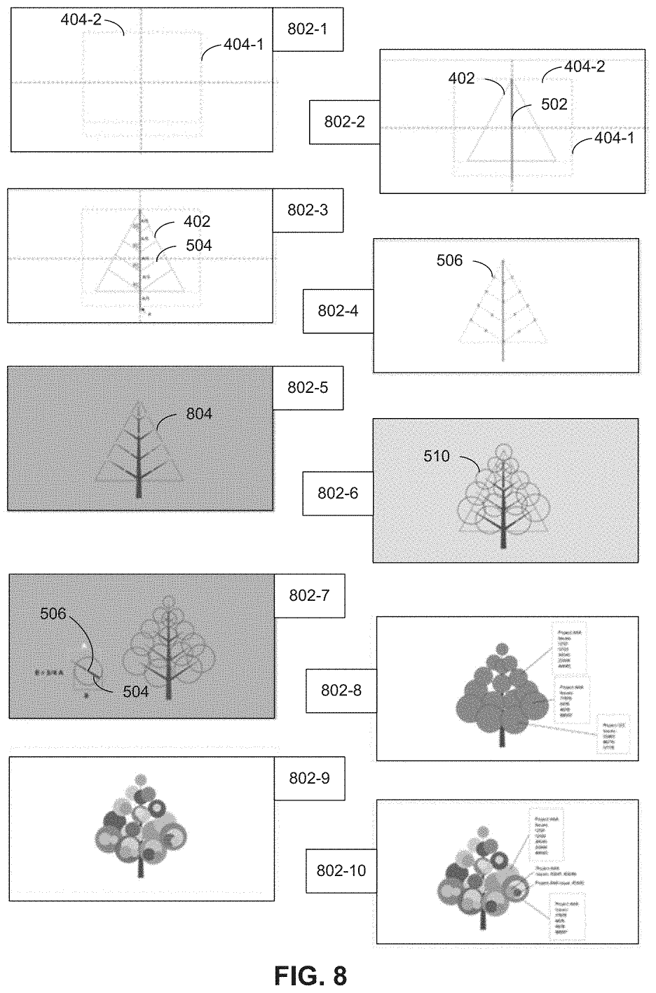

FIG. 8 is another depiction of a visualization 210 based on a layout 208 and generated by the visualization engine 206 of FIG. 2, according to various embodiments. In various embodiments and as shown, the visualization engine 206 generates a visualization 210 based on an object selected from an object library, such as a tree 402.

The visualization engine 206 first determines a shape of the tree 402. For example, at step 802-1, the visualization engine 206 initializes an image 204 to include a shape of the tree 402, including a height measurement of a height axis 404-1 and a length measurement of a length axis 404-2. In various embodiments, the shape of the tree 402 is based on the data set, such as the height measurement and the length measurement corresponding to a number of projects to be indicated by the visual elements of the tree 402.

After determined the shape of the tree 402, the visualization engine 206 determines a structure of the layout 208 according to the image 204 of the tree 402. At step 802-2, the visualization engine 206 determines a trunk 502 of the tree 402 within the height measurement of the height axis 404-1 and the length measurement of the length axis 404-2. At step 802-3, the visualization engine 206 determines a plurality of branches 504 of the tree 402 within the height measurement of the height axis 404-1 and the length measurement of the length axis 404-2. At step 802-4, the visualization engine 206 determines a set of locations 506 along the branches 504 of the tree 402. The locations 506 can be selected to indicate various features of the visual elements 410 to be shown at each location 506. For example, each branch 504 can be associated with a different project. Branches 504 that are closer to a base of the trunk 502 of the tree 402 are associated with dates that are older than the dates associated with branches 504 that are higher in the tree. Also, for each branch 504 of the tree, the distance from the trunk 502 can be associated with a progress of a project. Projects that are associated with visual elements 510 shown at locations 506 along a branch 504 that are closer to the trunk 502 of the tree 402 have progressed further to completion than projects that are associated with visual elements 510 shown at locations 506 that are further toward a tip of the branch 504. In this manner, familiar semantic properties of the tree 402 are incorporated into the layout 208, the determined locations of the layout 208, and the generated visual elements 508.

After determining the structure of the layout 208, the visualization engine 206 generates the image 204 of the tree 402. At step 802-5, the visualization engine 206 draws the trunk 502 and branches 504. The visualization engine 206 also draws leaves 804 at each determined location 506. The visualization engine 206 can also draw a background, such as a sky and/or ground texture.

After generating the image 204, the visualization engine 206 generates the visualization 210 including a first set of visual elements 510, each based on at least one data point of a data set. At step 802-6, the visualization engine 206 generates a visual element 510 for each at least one data point associated with a first set of data points of the data set, such as a first set of issues with an on-time status and the longest estimates of durations within each project included in the data set. The size of each visual element 510 indicates the duration of the issue. In particular, the layout is based on the size of the tree 402, and the visualization engine 206 scales the at least one of the visual elements 510 based on the size of the object. For example, the visual elements 510 can be scaled to fit along the branches 504 of the tree 402.

The visualization engine 206 associates each visual element 510 with a branch 504 of the tree 402. At step 802-7, the visualization engine 206 determines a location along each branch 504 for each visual element 510. In various embodiments, the distance of each visual element 510 indicates a progress to completion of the issue. At step 802-8, the visualization engine 206 generates a first layer of the visualization 210 including the visual elements 510 for the first set of projects. The color of each visual element 510 indicates a status of the issue.

Next, the visualization engine 206 generates additional layers of the visualization 210 by generating additional visual elements 510 for additional data points of the data set. At step 802-9, the visualization engine 206 generates additional visual elements 510 respectively corresponding to one or more data points of the data set that are associated with an issue of a second set of issues for each project, such as issues with an on-time status and shorter estimates of durations than the issues of the first set of issues. As shown, the visualization engine 206 adds the visual elements 510 indicating the second set of issues after adding the visual elements 510 indicating first set of issues. That is, the visualization engine 206 draws the visual elements 510 indicating the second set of issues on top of the visual elements 510 indicating the first set of issues. At step 802-10, the visualization engine 206 generates even more additional visual elements 510 respectively corresponding to a third set of issues for each project, such as issues with a slow, lagging, or delayed status. As shown, the visualization engine 206 adds the visual elements 510 indicating the third set of issues after adding the visual elements 510 indicating the first and second sets of issues. That is, the visualization engine 206 draws the visual elements 510 indicating the third set of issues on top of the visual elements 510 indicating the first and second sets of issues.

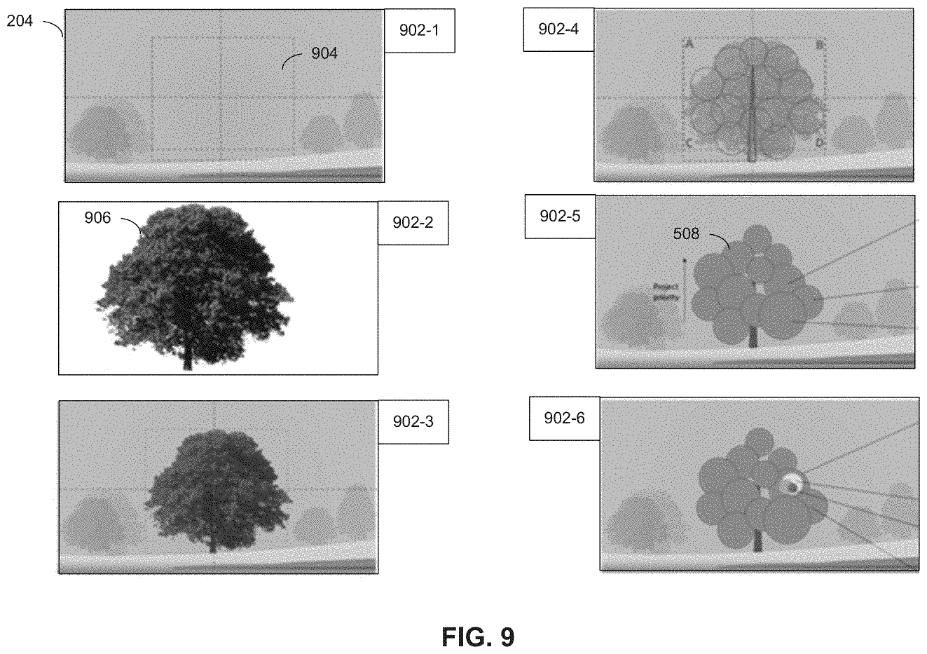

FIG. 9 is another depiction of a visualization 210 based on a layout 208 and generated by the visualization engine 206 of FIG. 2, according to various embodiments. In various embodiments and as shown, the visualization engine 206 includes, in the image 204, an object selected from an object library, such as a tree 402. Further, in various embodiments and as further shown in FIG. 9, a layout 208 of a visualization 210 is based on a shape of an object 908 included in the image 204. In various embodiments, the image 204 includes an object from nature that has semantic properties that are familiar to viewers.

At step 902-1, the visualization engine 206 determines an area 904 of the image 204 in which the object is to be included, such as an empty area of the image 204. At step 902-2, the visualization engine 206 receives the object 906. In various embodiments, the visualization engine 206 receives the object 906 from an object library stored by the server, receives the object 906 from another device, and/or receives the object 906 from a user. In various embodiments, the visualization engine 206 determines the object 906 based on the data set, such as discussed in relation to FIG. 6. At step 902-3, the visualization engine 206 includes the object 906 in the area 904 of the image 204.

At step 902-4, the visualization engine 206 determines one or more visual elements 508 for a first set of data points of the data set. Each visual element 508 indicates at least one data point of the data set. At step 902-5, the visualization engine 206 determines locations and sizes of the first set of visual elements 508 according to a layout. In various embodiments, the visualization engine 206 determines the layout of the visual elements 508 according to various data properties of the data set. As shown, the shape of the set of visual elements 508 corresponds to the shape of the tree included in the object 906. At step 902-6, the visualization engine 206 adds visual elements 508 for one or more additional sets of data points of the data set (e.g., one or more additional layers that are drawn on top of the first set of visual elements 508). In various embodiments, an appearance of each visual element relates one or more semantic properties of the object in the image to one or more features of the data indicated by the visual element.

In various embodiments, the visualization engine 206 determines the layout based on the visual elements to be included in the visualization. For example (without limitation), instead of determining a layout and then determining locations within the layout for the visual elements, the visualization engine 206 can determine the visual elements to be included in the visualization and then determine layout and the positions based on the determined visual elements. The visualization engine 206 can determine the layout based on a number, sizes, and/or shapes of the visual elements, such that the visual elements. As shown in FIG. 9, the locations can be selected such that the overall shape of the visual elements corresponds to a shape of the tree in the image 204. In various embodiments, the layout is based on one or more semantic properties of a structure of an object in the image, where such semantic properties are familiar to viewers.

Although not shown, in various embodiments, different areas 904 of a layout can be reserved for different subsets of a data set 202. For example, the data set 202 includes data points associated with one or more projects. The layout of a tree can associate each branch of the tree with a particular project. For each an area of the layout that is associated with a subset of data points of the data set, the visualization engine can include visual elements that indicate at least one data point of the subset of data points. That is, the visualization engine can locate each visual element on a particular branch based on the project with which each visual element is associated and the associations of branches to projects. By generating visualizations in which the locations and/or appearance of visual elements are based on familiar semantic properties of an object in the image, such as an object in nature, the visualization engine generates visualizations of the complex data that are familiar to and intuitively understood by viewers.

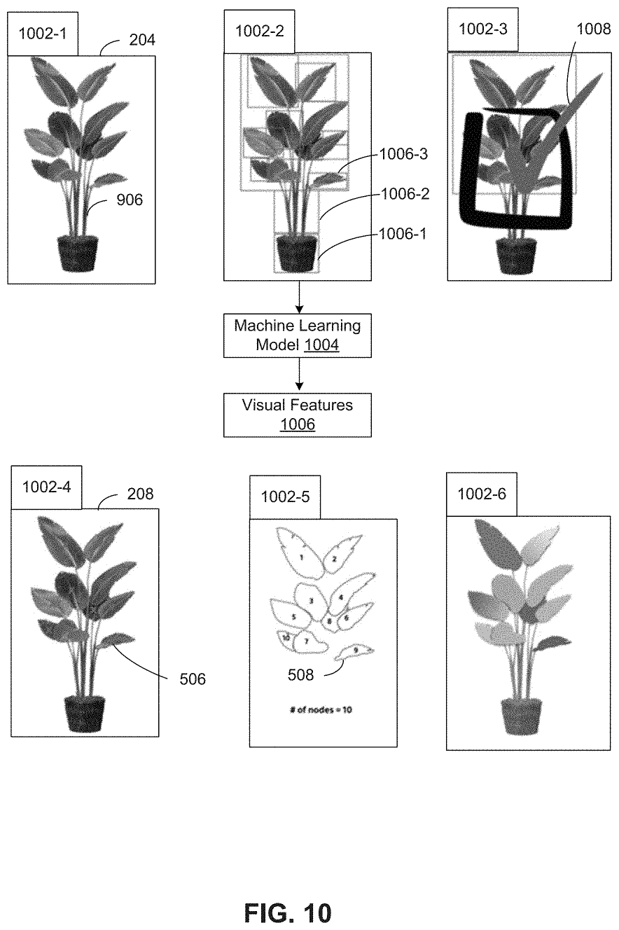

FIG. 10 is another depiction of a visualization 210 based on a layout 208 and generated by the visualization engine 206 of FIG. 2, according to various embodiments. In various embodiments and as shown, the visualization engine 206 can determine a layout 208 of a visualization 210 based on processing an image 204 by a machine learning model 1004.

At step 1002-1, the visualization engine 206 receives an image 204 including an object 906, such as a plant. In various embodiments, the visualization engine 206 retrieves the image 204 from an object library stored by the server, receives the image 204 from another device, and/or receives the image 204 from a user.

At step 1002-2, the visualization engine 206 processes the image 204 by a machine learning model 1004. The machine learning model 1004 can include, for example (without limitation), one or more computer vision models, such as one or more convolutional neural networks that determine a feature set of visual features 1006 of the image 204. As shown, machine learning model 1004 determines a number of visual features 1006 in the image 204, as shown by red rectangles. A first visual feature 1006-1 includes a base or pot of the plant. A second visual feature 1006-2 includes a stem of the plant. A third visual feature 1006-3 includes a leaf of the plant. The visual features 1006 can include one or more semantic properties of the plant, such as the structure of the plant or the size or color of the leaves.

At step 1002-3, the visualization engine 206 shows the determined visual features 1006 to a user. The visualization engine 206 receives, from the user, a confirmation 1008 of the determined visual features 1006, and continues to step 1002-4. If the user does not provide the confirmation 1008, the visualization engine 206 can reprocess the image 204 with the machine learning model and/or process the image 204 with a different machine learning model to determine a different set of visual features 1006, ask the user to annotate the image 204, and/or ask the user to provide a different image 204.

At step 1002-4, the visualization engine 206 determines a layout 208 for a visualization 210. The layout 208 includes one or more locations 506 within the image 204. In various embodiments, the visualization engine 206 determines the layout 208 based on an output of the machine learning model 1004 or another machine learning model, where the output indicates the locations 506 within the image 204 based on the determined visual features 1006. For example (without limitation), the visualization engine 206 can determine each location 506 based on the visual features 1006 that include one or more leaves of the plant. The layout can be based on the structure of the plant shown in the image, where the structure of the plant reflects semantic properties that are familiar to viewers.

At step 1002-5, the visualization engine 206 determines a set of visual elements 508 based on a data set. As shown, the visualization engine 206 generates ten visual elements 508. In various embodiments, each visual element 508 corresponds to at least one data point of the data set that is associated with a project, task, or issue. Each visual element 508 is based on a size and/or shape of a corresponding visual feature 1006 determined by the machine learning model 1004, such as a size and/or shape of a leaf of the plant. The location of each visual element 508 is based on the layout 208 and the corresponding at least one data point of the data set.

At step 1002-6, the visualization engine 206 generates the visualization 210 including the visual elements 508. In various embodiments and as shown, the visualization engine 206 generates each visual element 508 to include a visual property, such as a color, where each color is associated with a data property of the one or more data points indicated by the visual elements 508 (e.g., a status of a project or issue).

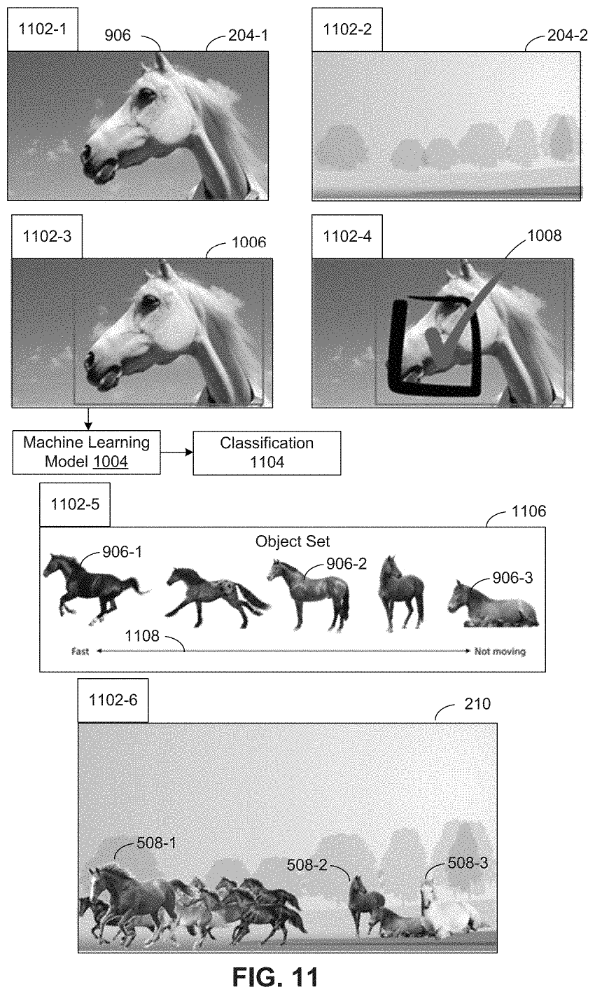

FIG. 11 is another depiction of a visualization 210 based on a layout 208 and generated by the visualization engine 206 of FIG. 2, according to various embodiments. In various embodiments and as shown, the visualization engine 206 can determine content of a visualization 210 based on processing an image 204 by a machine learning model 1004.

At step 1102-1, the visualization engine 206 receives, from a user, a first image 204-1 including one or more objects 906 to be included in a visualization 210. The object can include an animal, such as a horse, or a plant, such as a tree.

At step 1102-2, the visualization engine 206 receives, from the user, a second 204-2 image to be used as a background of the visualization 210. The background can include a nature scene, such as a field. Although not shown, the visualization engine 206 can determine a layout of the second image 204, such as areas of the field where visual elements 508 including different objects 906 can be included.

At step 1102-3, the visualization engine 206 processes the first image 204-1 by a machine learning model 1004. The machine learning model 1004 identifies the object 906 in the first image 204-1 and output a classification 1104, such as a determination that the object 906 in the first image 204-1 is a horse. The machine learning model 1004 can include, for example (without limitation), one or more computer vision models, such as one or more can include one or more convolutional neural networks that determine a feature set of visual features 1006 of the image 204-1. Based on the visual features 1006 of the first image 204-1, the machine learning model 1004 can determine the classification 1104 of the object 906 based on a set of object classes, such as types of animals, types of plants, or other types of objects.

At step 1102-4, the visualization engine 206 presents the first image 204-1, including the classification 1104 determined by the machine learning model 1004, to the user. The visualization engine 206 receives, from the user, a confirmation 1008 of the classification 1104 of the object 906 in the first image 204-1, and continues to step 1102-5. If the user does not provide the confirmation 1008, the visualization engine 206 can reprocess the first image 204-1 with the machine learning model and/or process the first image 204-1 with a different machine learning model to determine a different classification 1104 of the object 906 in the first image 204-1, ask the user to perform the classification 1104 of the object 906, and/or ask the user to provide a different first image 204-1.

At step 1102-5, the visualization engine 206 receives an object set 1106 of objects that have the same or similar classification 1104 as the object 906 in the first image 204-1, such as an object set 1106 including images of horses. The object set 1106 can be retrieved, for example, from an object library of classified objects stored by the server 101, received from another device, and/or received from the user. Each object 906 of the object set 1106 is associated with a visual property 1108, such as a speed of each horse. For example, a first object 906-1 includes a horse with a first value of the visual property 1108 (e.g., a galloping horse). A second object 906-2 includes a horse with a second value of the visual property 1108 (e.g., a standing or walking horse), A third object 906-3 includes a horse with a third value of the visual property 1108 (e.g., a horse lying down).

Although not shown, the visualization engine 206 receives a data set and determines locations of visual elements 508 to be included in the visualization 210, For example (without limitation), the visualization engine 206 can receive a data set and choose, from the object set 1106, an object 906 to represent each at least one data point of the data set, such as at least one data point associated with each project or issue indicated in the data set. In particular, the visualization engine 206 can select, for the visual element 508 of each at least one data point, an object 906 that includes a visual property that corresponds to a data property of the at least one data point. For example (without limitation), for a first project that is moving fast, the visualization engine 206 can select the first object 906-1 of a horse that is moving fast. For a visual element 508-3 of a second project that is moving slowly, the visualization engine 206 can select the second object 906-2 including a horse that is walking or standing. For a visual element 508-3 of a third project that is stalled, the visualization engine 206 can select the third object 906-3 including a horse that is lying down. The visual features of each horse reflect semantic properties that are familiar to viewers, and that can be associated with the visual elements 508 to convey features of the data points of the data set.

At step 1102-6, the visualization engine 206 generates a visualization 210 that includes the visual elements 508 indicating each of the at least data points. The visualization 210 is based on the determined locations of the layout 208. For example, the visualization engine 206 includes the first visual element 508-1 indicating the first at least one data point associated with the first project at a first location of the visualization 210, such as a first location of the field. The visualization engine 206 includes the second visual element 508-2 indicating the second at least one data point associated with the second project at a second location of the visualization 210, such as a second location of the field. The visualization engine 206 includes the third visual element 508-3 indicating the second at least one data point associated with the third project at a third location of the visualization 210, such as a third location of the field. In various embodiments, the visualization 210 can include an animation, such as a video in which the horses move around the field based on the visual property of each visual element 508. Further, the layout can include a time point of the animation at which a first visual element 508 appears in the animation based on a data feature of the at least one data point indicated by the first visual element 508. For example, the horses can be shown to appear and/or run across the screen based on a chronology and/or status of the project indicated by each horse.

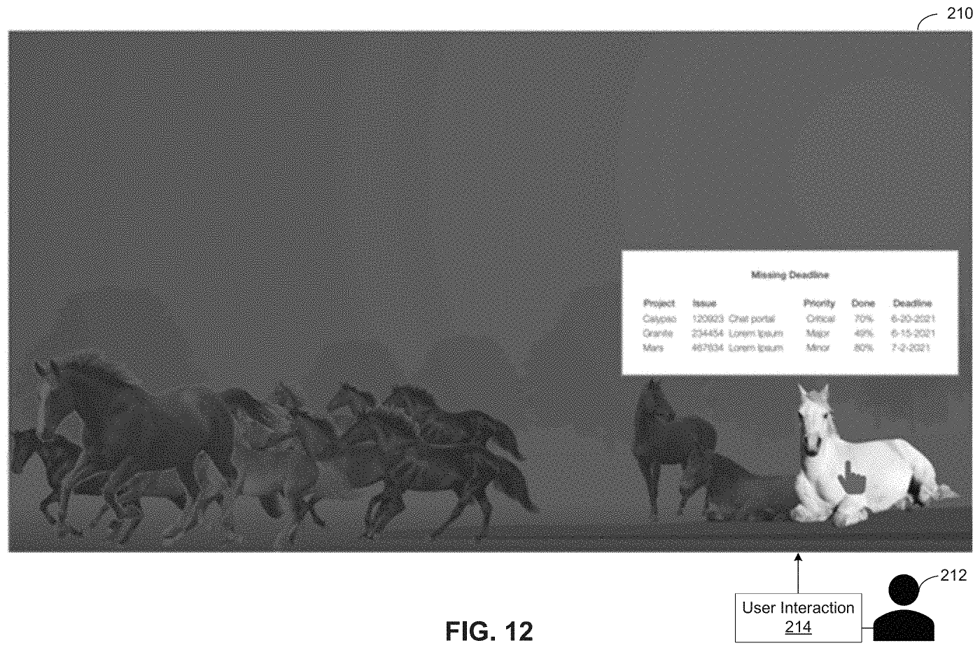

FIG. 12 is a depiction of a user interaction with the visualization 210 of FIG. 11, according to various embodiments. In various embodiments and as shown, the visualization engine 206 presents an interactive visualization 210.

As shown, the visualization engine 206 displays the visualization 210 to a user 212 and receives, from the user 212, a user interaction 214. For example (without limitation), the user 212 can perform a click or select operation on a portion of the visualization 210 including the third visual element 508-3. Based on the user interaction 214, the visualization engine 206 updates the visualization 210 (e.g., by highlighting the third visual element 508-3 relative to the other visual elements 508 and the background of the visualization 210). The visualization engine 206 can also insert additional information into the visualization 210 about the third visual element 508-3, such as information about the at least one data point indicated by the third visual element 508-3. The visualization engine 206 displays the updated visualization to the user 212.

In various embodiments, the user interaction indicates a filter to be applied to the visualization. For example, the user can specify one or more filter criteria, such as projects or issues of a particular type and/or arising within a selected date range. The visualization engine can select one or more data points from the data set based on one or more filter criteria of a filter and update the image based on the selected one or more data points (e.g., limiting the visual elements to those that indicate at least one data point that fulfills the one or more filter criteria).

In various embodiments, the user interaction indicates a visual element limit, such as a maximum number of visual elements 508 to be included in the visualization 210. Alternatively or additionally, the visualization engine can determine a visual element limit, such as a maximum number of visual elements 508 that can be arranged according to the determined layout 208 of the visualization 210. Based on the visual element limit, the visualization engine 206 can limit the one or more data points of the data set. For example, the visualization engine can limit and/or reduce the number of visual elements 508 included in the visualization 210 based on the visual element limit.

In various embodiments, at least one of the one or more visual elements is initially hidden. For example, the visualization 210 can initially include only the visual elements 508 of a first layer of the visual elements 508, such as the first layer of visual elements 508 as discussed in relation to FIG. 8, Based on user input, the visualization engine 206 can reveal a hidden one of the one or more visual elements. For example, based on the user clicking on the visualization 210, the visualization engine 206 can insert a second or higher layer of visual elements, such as discussed in relation to FIG. 8. In this manner, the visualization engine 206 can respond to user interaction by adjusting the presentation of the visualization 210.

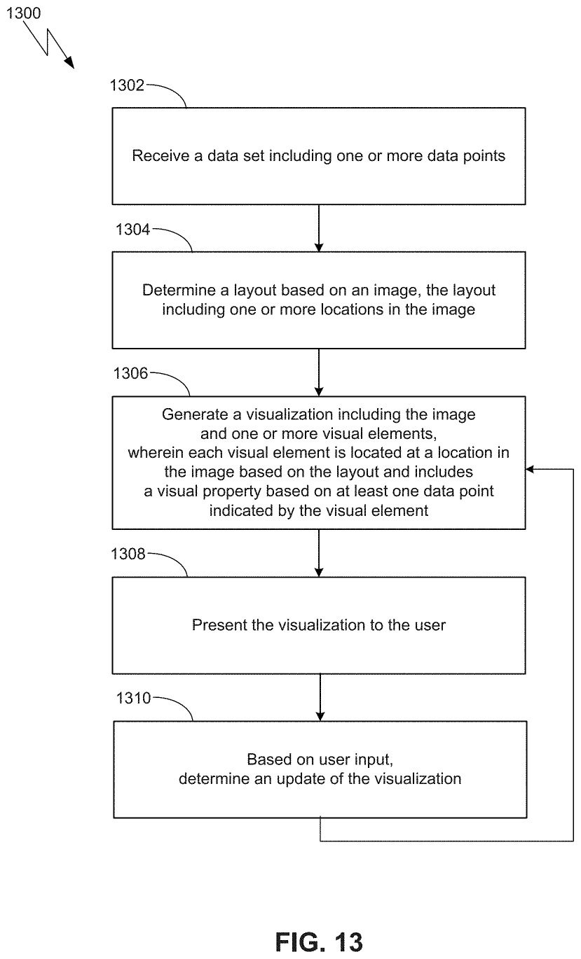

FIG. 13 is a flow diagram of method steps for configuring a computer system to generate visualizations, according to various embodiments. In various embodiments, the method steps are performed by the visualization engine 206 of FIG. 2.

A method 1300 begins at step 1302, in which the visualization engine receives a data set including one or more data points. In various embodiments, the visualization engine receives the data set via one or more APIs 308 of one or more data sources 306, such as shown in FIG. 3.

At step 1304, the visualization engine determines a layout based on the image. The layout includes one or more locations in the image where a visual element indicating at least one data point can be included. In various embodiments, the layout is based on a determined structure of the image, such as shown in FIG. 4.

At step 1306, the visualization engine generates a visualization including the image and one or more visual elements. Each visual element is located at a location in the image based on the layout. In various embodiments, the visualization engine determines the location of each visual element based on the at least one data point indicated by the visual element, such as shown in FIG. 5. In various embodiments, each visual element includes a visual property based on the at least one data point indicated by the visual element, such as shown in FIGS. 6 and 11.

At step 1308, the visualization engine presents the visualization to the user. In various embodiments, the visualization engine displays the visualization to the user via a display device, such as the display device 110 of FIG. 2. In various embodiments, the visualization engine transmits the visualization to another device for displaying to the user, such as transmitting a web page a client device to be displayed in a web browser.

At step 1310, the visualization engine determines an update of the visualization based on user input. For example (without limitation), the user input can indicate a selection of a visual element, and the visualization engine can determine that the visualization is to be updated by adding information about at least one data point indicated by the selected visual element, such as shown in FIG. 12. As another example, the user input can indicate a selection of a visual element, and the visualization engine can perform a drill-down operation by determining one or more additional data points of the data set, where the one or more additional data points are associated with the at least one data point indicated by the selected visual element. The visualization engine can update the visualization to include additional visual elements based on the one or more additional data points. The visualization engine can also highlight the selected visual element and/or remove one or more visual elements other than the visual element selected by the user input. The method returns to step 1306 to generate the updated visualization for presentation to the user.

In sum, the visualization engine re elves a data set, such as via an API of a data source. The visual engine determines a layout of an image, where the layout includes one or more locations. The locations can be based on a structure of the image, such as a structure of a tree included in the image. The visualization engine generates one or more visual elements, where each visual element is associated with at least one data point of a data set. The visualization engine generates a visualization in which each visual element is included at one of the locations of the layout. The locations of the visual elements provide additional information about the at least one data point indicated by the visual element. The visualization engine displays the visualization for a user.

At least one technical advantage of the disclosed techniques relative to the prior art is that, with the disclosed techniques, the visualization of the complex data is organized according to a layout of an image, where the location of each visual element included in the visualization provides information about at least one data point indicated by the visual element. The locations of the data points within the image can reflect aspects of the data points according to the context of the image, such as an arrangement of branches of a tree that reflect relationships among the data points indicated by each visual element of the visualization. As another technical advantage, automatically determining the layout based on the image and generating the visualization according to the layout can reduce an involvement of a user in designing and organizing the visualization. These technical advantages provide one or more technological improvements over prior art approaches.

1. In some embodiments, a method comprises receiving a data set including one or more data points; determining a layout based on an image, the layout including one or more locations in the image; generating a visualization including the image and one or more visual elements, wherein each visual element indicates at least one data point of the data set, and each visual element is located in the visualization at a location of the one or more locations of the layout based on the at least one data point indicated by the visual element; and displaying the visualization.

2. The method of clause 1, wherein each data point of the one or more data points is associated with a project of an organization, the layout is based on a structure of a tree included in the image, and the location of each visual element in the visualization corresponds to a hierarchical position within the organization of the project that is indicated by the visual element.

3. The method of clauses 1 or 2, wherein the image includes an object that is associated with a structure, and at least one of the one or more locations of the layout is based on the structure of the object.

4. The method of any of clauses 1-3, wherein a first location of a first visual element indicating a first at least one data point is based on a location of a second visual element indicating a second at least one data point and a data feature that is associated with both the first at least one data point and the second at least one data point.

5. The method of any of clauses 1-4, wherein an area of the layout is associated with a subset of data points of the data set, and visual elements that indicate at least one data point of the subset of data points are located in the area.

6. The method of any of clauses 1-5, wherein the image includes a visual relationship between a first location and a second location, the data set includes a data relationship between a first at least one data point and a second at least one data point, and a location of a first visual element that indicates the first at least one data point and a location of a second visual element that indicates the second at least one data point are based on an association of the visual relationship with the data relationship.

7. The method of any of clauses 1-6, wherein the layout is based on a size of an object included in the image, and the method further comprises scaling at least one of the one or more visual elements based on the size of the object.

8, The method of any of clauses 1-7, wherein the layout is based on a shape of an object included in the image, and a shape of the one or more visual elements of the visualization corresponds to the shape of the object.

9. The method of any of clauses 1-8, further comprising processing the image by a machine learning model, wherein the layout is based on an output of the machine learning model.

10. The method of any of clauses 1-9, further comprising processing the image by a machine learning model to determine a classification of one or more objects in the image, and at least one visual element includes at least one visual property based on the classification of the one or more objects.

11. In some embodiments, one or more non-transitory computer readable media stores instructions that, when executed by one or more processors, cause the one or more processors to perform the steps of receiving a data set including one or more data points; determining a layout based on an image, the layout including one or more locations in the image; generating a visualization including the image and one or more visual elements, wherein each visual element indicates at least one data point of the data set, and each visual element is located in the visualization at a location of the one or more locations of the layout based on the at least one data point indicated by the visual element; and displaying the visualization.

12. The one or more non-transitory computer readable media of clause 11, wherein a first visual element indicating a first at least one data point that is associated with a type includes a first color of a color scheme, and a second visual element indicating a second at least one data point that is associated with the type includes a second color of the color scheme that is different than the first color.

13. The one or more non-transitory computer readable media of clauses 11 or 12, wherein a first visual element includes a first color of a color scheme, and a second visual element that is adjacent to the first visual element includes a second color of the color scheme that is different than the first color.

14. The one or more non-transitory computer readable media of any of clauses 11-13; wherein the steps further comprise inserting, into the image, one or more objects included in an object library, wherein the one or more objects are based on at least one data point of the data set.

15. The one or more non-transitory computer readable media of clauses 11-14, wherein the steps further comprise inserting, into the image, one or more objects included in an object library, wherein the layout is based on the one or more objects inserted into the image.

16. The one or more non-transitory computer readable media of clauses 11-15, wherein the visualization includes an animation, and the layout includes a time point of the animation at which a first visual element appears in the animation based on a data feature of the at least one data point indicated by the first visual element.

17. In some embodiments, a system comprises a memory that stores instructions, and a processor that is coupled to the memory and, when executing the instructions, is configured to receive a data set including one or more data points; determine a layout based on an image, the layout including one or more locations in the image; generate a visualization including the image and one or more visual elements, wherein each visual element indicates at least one data point of the data set; and each visual element is located in the visualization at a location of the one or more locations of the layout based on the at least one data point indicated by the visual element; and display the visualization.

18. The system of clause 17, wherein the processor is further configured to select one or more data points from the data set based on one or more filter criteria of a filter.

19. The system of clauses 17 or 18, wherein the layout includes a visual element limit, and receiving the data set further comprises limiting the one or more data points of the data set based on the visual element limit.

20. The system of any of clauses 17-19, wherein at least one of the one or more visual elements is initially hidden, and the processor is further configured to reveal a hidden one of the one or more visual elements based on a user input.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Any and all combinations of any of the claim elements recited in any of the claims and/or any elements described in this application, in any fashion, fall within the contemplated scope of the embodiments and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A method, comprising:
receiving a data set including one or more data points;
determining a layout based on an image, the layout including one or more locations in the image;
generating a visualization including the image and one or more visual elements, wherein each visual element indicates at least one data point of the data set, and each visual element is located in the visualization at a location of the one or more locations of the layout based on the at least one data point indicated by the visual element; and
displaying the visualization.

2. The method of claim 1, wherein each data point of the one or more data points is associated with a project of an organization, the layout is based on a structure of a tree included in the image, and the location of each visual element in the visualization corresponds to a hierarchical position within the organization of the project that is indicated by the visual element.

3. The method of claim 1, wherein the image includes an object that is associated with a structure, and at least one of the one or more locations of the layout is based on the structure of the object.

4. The method of claim 1, wherein a first location of a first visual element indicating a first at least one data point is based on a location of a second visual element indicating a second at least one data point and a data feature that is associated with both the first at least one data point and the second at least one data point.

5. The method of claim 1, wherein an area of the layout is associated with a subset of data points of the data set, and visual elements that indicate at least one data point of the subset of data points are located in the area.

6. The method of claim 1, wherein the image includes a visual relationship between a first location and a second location, the data set includes a data relationship between a first at least one data point and a second at least one data point, and a location of a first visual element that indicates the first at least one data point and a location of a second visual element that indicates the second at least one data point are based on an association of the visual relationship with the data relationship.

7. The method of claim 1, wherein the layout is based on a size of an object included in the image, and the method further comprises scaling at least one of the one or more visual elements based on the size of the object.

8. The method of claim 1, wherein the layout is based on a shape of an object included in the image, and a shape of the one or more visual elements of the visualization corresponds to the shape of the object.

9. The method of claim 1, further comprising processing the image by a machine learning model, wherein the layout is based on an output of the machine learning model.

10. The method of claim 1, further comprising processing the image by a machine learning model to determine a classification of one or more objects in the image, and at least one visual element includes at least one visual property based on the classification of the one or more objects.

11. One or more non-transitory computer readable media storing instructions that, when executed by one or more processors, cause the one or more processors to perform the steps of:
receiving a data set including one or more data points;
determining a layout based on an image, the layout including one or more locations in the image;
generating a visualization including the image and one or more visual elements, wherein each visual element indicates at least one data point of the data set, and each visual element is located in the visualization at a location of the one or more locations of the layout based on the at least one data point indicated by the visual element; and
displaying the visualization.

12. The one or more non-transitory computer readable media of claim 11, wherein a first visual element indicating a first at least one data point that is associated with a type includes a first color of a color scheme, and a second visual element indicating a second at least one data point that is associated with the type includes a second color of the color scheme that is different than the first color.

13. The one or more non-transitory computer readable media of claim 11, wherein a first visual element includes a first color of a color scheme, and a second visual element that is adjacent to the first visual element includes a second color of the color scheme that is different than the first color.

14. The one or more non-transitory computer readable media of claim 11, wherein the steps further comprise inserting, into the image, one or more objects included in an object library, wherein the one or more objects are based on at least one data point of the data set.

15. The one or more non-transitory computer readable media of claim 11, wherein the steps further comprise inserting, into the image, one or more objects included in an object library, wherein the layout is based on the one or more objects inserted into the image.

16. The one or more non-transitory computer readable media of claim 11, wherein the visualization includes an animation, and the layout includes a time point of the animation at which a first visual element appears in the animation based on a data feature of the at least one data point indicated by the first visual element.

17. A system, comprising:
a memory that stores instructions, and
a processor that is coupled to the memory and, when executing the instructions, is configured to:
receive a data set including one or more data points;
determine a layout based on an image, the layout including one or more locations in the image;
generate a visualization including the image and one or more visual elements, wherein each visual element indicates at least one data point of the data set, and each visual element is located in the visualization at a location of the one or more locations of the layout based on the at least one data point indicated by the visual element; and
display the visualization.

18. The system of claim 17, wherein the processor is further configured to select one or more data points from the data set based on one or more filter criteria of a filter.

19. The system of claim 17, wherein the layout includes a visual element limit, and receiving the data set further comprises limiting the one or more data points of the data set based on the visual element limit.

20. The system of claim 17, wherein at least one of the one or more visual elements is initially hidden, and the processor is further configured to reveal a hidden one of the one or more visual elements based on a user input.
